(19) United States
(12) Patent Application Publication
(10) Pub. No.: US 2021/0072938 A1
(43) Pub. Date: Mar. 11, 2021

(54) PRINTER FILTER PIPELINE COMPRISING CUSTOM PRINTER FILTER

(71) Applicant: Hewlett-Packard Development Company, L.P., Spring, TX (US)

(72) Inventors: Sang Min LEE, Seongnam-si (KR); Mi Kyung CHOI, Seongnam-si (KR)

(21) Appl. No.: 17/049,427

(22) PCT Filed: Jan. 7, 2019
(86) PCT No.: PCT/KR2019/000183

§ 371 Date: Oct. 21, 2020

(30) Foreign Application Priority Data
Aug. 30, 2018 (KR) 10-2018-0102877

(51) Int. Cl. G06F 3/12

(52) U.S. Cl. CPC G06F 3/1277; G06F 3/1203

(57) ABSTRACT

An apparatus for configuring a printer filter pipeline is provided. The apparatus includes a processor and a memory storing instructions executable by the processor. The processor executes the instructions to drive a printer filter pipeline manager to load a custom printer filter manager based on a printer filter configuration file provided by a printer driver and to drive the custom printer filter manager to load a custom printer filter based on custom printer filter configuration information comprising information related to a custom printer filter defined by a user.

### BACKGROUND ART

A printer driver, which is a part of an operating system that changes a printing job target into a form printable by a printer, is a program that converts a command to be delivered from an application to the printer into a command for controlling the printer.

A printer has a different operating scheme according to a type and a model thereof, such that a printer driver offered by a vendor may differ with the type and the model of the printer. Thus, to perform printing using printers, a printer driver corresponding to each printer needs to be installed in a printer control device.

### BRIEF DESCRIPTION OF DRAWINGS

The above and other aspects, features, and advantages of various examples of the disclosure will be more apparent from the following description taken in conjunction with the accompanying drawings, in which:

FIG. 1 is a diagram for describing a printing service environment including an apparatus for configuring a printer filter pipeline and an image forming apparatus, according to an example;

FIG. 2 is a block diagram for describing an apparatus for configuring a printer filter pipeline and an image forming apparatus, according to an example;

FIG. 3 is a diagram for describing operations of a processor of an apparatus for configuring a printer filter pipeline, according to an example;

FIG. 4 is a diagram for describing a process of configuring a printer filter pipeline, according to an example;

FIG. 5 is a diagram for describing a printer filter configuration file, according to an example;

FIG. 6 is a diagram for describing custom printer filter configuration information, according to an example;

FIG. 7 is a diagram for describing a process of configuring a printer filter pipeline, according to an example; and

FIG. 8 is a flowchart for describing a method of configuring a printer filter pipeline, according to an example.

Throughout the drawings, it should be noted that like reference numbers are used to depict the same or similar elements, features, parts, components, and structures.

### MODE FOR THE INVENTION

Hereinafter, various examples will be described with reference to the accompanying drawings. The examples described hereinafter may be modified in many different forms. To more clearly describe features of examples, matters well known to one of ordinary skill in the art to which the below examples pertain will not be described in detail.

In the specification, an “image forming job” may denote any one of various jobs (for example, printing, copying, scanning, and faxing) related to an image, such as forming of an image or generating/storing/transmitting of an image file, and a “job” may denote not only an image forming job, but may also denote a series of processes required to perform the image forming job.

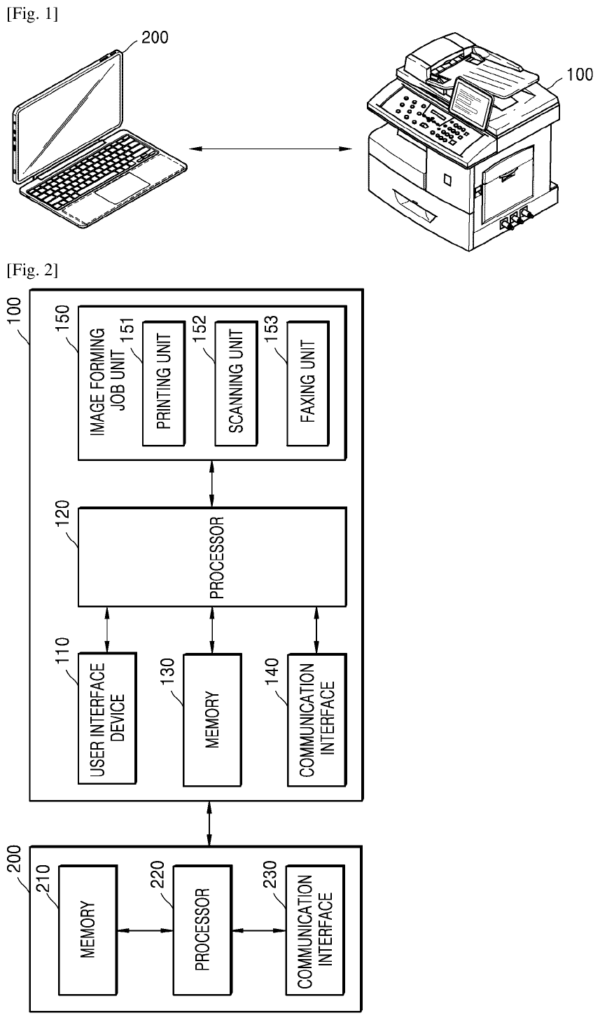

FIG. 1 is a diagram for describing a printing service environment including an apparatus for configuring a printer filter pipeline and an image forming apparatus, according to an example.

Referring to FIG. 1, an image forming apparatus 100 may perform an image forming job such as printing, copying, scanning, faxing, and the like and may refer to a printer, a copier, a scanner, a fax, a multi-functional printer, and so forth. As an example, the image forming apparatus 100 may perform printing with respect to a printing job target determined by a user. For printing by the image forming apparatus 100, a printing job target has to be delivered in a form printable by the image forming apparatus 100. To this end, the user may drive a printer driver in a device 200 for controlling the image forming apparatus 100, e.g., a personal computer (PC) to convert the printing job target into a form printable by the image forming apparatus 100 and to send the same to the image forming apparatus 100.

An apparatus for configuring the printer filter pipeline may be a separate device or may be included in the device 200 for controlling the image forming apparatus 100. The following description is made of an example in which the apparatus for configuring a printer filter pipeline is included in a device for controlling the image forming apparatus.

FIG. 2 is a block diagram for describing an apparatus for configuring a printer filter pipeline and an image forming apparatus, according to an example.

Referring to FIG. 2, the image forming apparatus 100 may include a user interface device 110, a processor 120, a memory 130, a communication interface 140, and an image forming job unit 150. Although not shown, a power supply unit for supplying power to each component may be further included in the image forming apparatus 100.

The user interface device 110 may include an input unit for receiving an input for performing an image forming job, or the like from the user and an output unit for displaying information such as a result of performing the image forming job, a state of the image forming apparatus 100, or the like. For example, the user interface device 110 may have the form of a touch screen including an operation panel that receives a user input, a display panel that displays a screen, and so forth.

The processor 120 may control an operation of the image forming apparatus 100, and may include at least one processing unit such as a central processing unit (CPU), or the like. The processor 120 may control other components included in the image forming apparatus 100 to perform an operation corresponding to the user input received through the user interface device 110. The processor 120 may include at least one specialized processing unit corresponding to each unit or may have an integral form.

The processor 120 may execute a program stored in the memory 130, read data or a file stored in the memory 130, or store a new file in the memory 130.

The memory 130 may install and store a program such as an application and various types of data such as a file or the like. The processor 120 may access and use data stored in the memory 130 or store new data in the memory 130. The processor 120 may execute a program installed in the memory 130. The processor 120 may also install an application, which is received from an external source through the communication interface 140, in the memory 130.

The communication interface 140 may perform wireless/wired communication with another device or a network. To this end, the communication interface 140 may include a communication module (e.g., transceiver) supporting at least one of various wireless/wired communication methods. For example, a communication module may have the form of a chipset or may be a sticker/barcode (e.g., a sticker including a near field communication (NFC) tag), or the like.

The wireless communication may include, for example, wireless fidelity (Wi-Fi), WiFi Direct, Bluetooth, ultra-wide band (UWB), NFC, and so forth. The wired communication may include, for example, ethernet, universal serial bus (USB), a high definition multimedia interface (HDMI), and so forth.

The communication interface 140 may be connected with an external device located outside the image forming apparatus 100 and transmit and receive a signal or data to and from the external device. The communication interface 140 may deliver the signal or the data received from an external device to the processor 120 or transmit a signal or data generated in the processor 120 to the external device. For example, once the communication interface 140 receives a print command signal and a printing job target from the external device, the processor 120 may output the received printing job target through a printing unit 151.

The image forming job unit 150 may perform an image forming job such as printing, copying, scanning, faxing, and the like. While it is illustrated in FIG. 2 that the image forming job unit 150 includes the printing unit 151, a scanning unit 152, and a faxing unit 153, the image forming job unit 150 may include only some components thereof or may further include components to perform other types of image forming jobs.

The printing unit 151 may form an image on a recording medium by using various printing schemes such as an electrophotography scheme, an inkjet scheme, a thermal transfer scheme, a direct thermal scheme, and the like. The scanning unit 152 may read in an image recorded on a manuscript by irradiating light onto the manuscript and receiving light reflected therefrom. The faxing unit 153 may share a component for scanning an image with the scanning unit 152, share a component for printing a received file with the printing unit 151, and transmit a scanned file to a destination or receive a file from an external source.

The apparatus 200 for configuring the printer filter pipeline according to an example may include a memory 210, a processor 220, and a communication interface 230. The apparatus 200 for configuring the printer filter pipeline may be the device for controlling the image forming apparatus 100.

The memory 210 may store instructions executable by the processor 220. Also, the memory 210 may store an operating system and application programs.

The processor 220 may execute instructions stored in the memory 210 to generate a printer filter pipeline. The printer filter may perform predetermined processing with respect to the printing job target such that the printer performs printing. The printer filter may perform different types of processing depending on a type of the printer filter. For example, the types of the printer filter may include an N-up printer filter, a watermark/overlay printer filter, a rendering printer filter, and so forth. The printing job target may be converted into a final form printable by the printer after sequentially undergoing a printer filter pipeline, that is, a series of printer filters.

For example, the processor 220 may drive a printer filter pipeline manager to load a custom printer filter manager and may load the custom printer filter manager based on a printer filter configuration file provided by the printer driver. Based on the printer filter configuration file, according to an operating order of printer filters provided by the printer driver and the custom printer filter manager, the processor 220 may load the printer filters together with the custom printer filter manager. The processor 220 may drive the custom printer filter manager to load a custom printer filter based on custom printer filter configuration information including information related to a user-defined custom printer filter. The processor 220 may configure a printer filter pipeline by loading a printer filter and/or a custom printer filter.

The communication interface 230 may transmit the printing job target processed by the printer filter pipeline in the apparatus 200 for configuring the printer filter pipeline to the image forming apparatus 100.

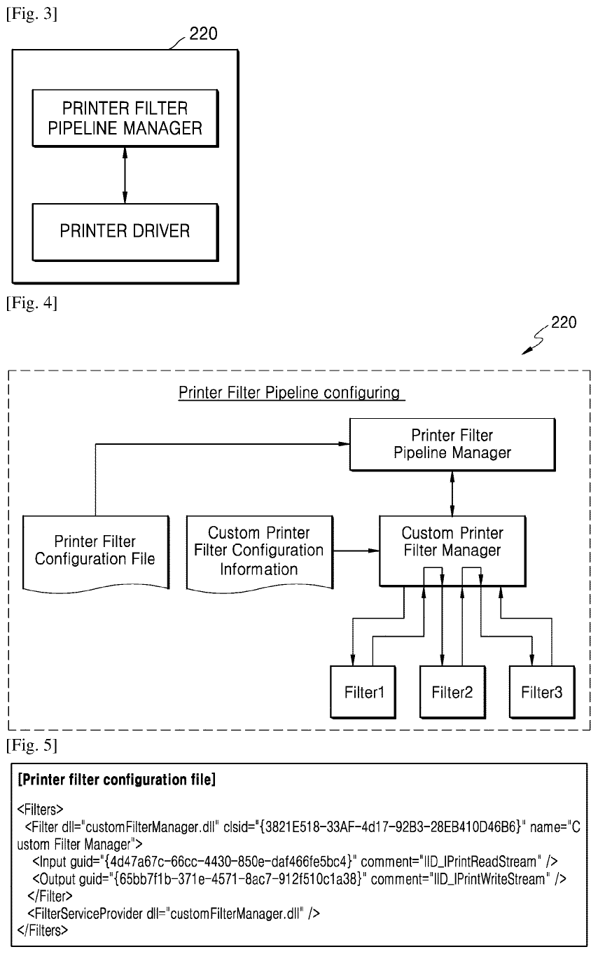

FIG. 3 is a diagram for describing operations of a processor of an apparatus for configuring a printer filter pipeline, according to an example.

Referring to FIG. 3, the processor 220 may drive a printer filter pipeline manager and a printer driver to configure a printer filter pipeline. The printer filter pipeline manager may manage printer filters constituting the printer filter pipeline. The printer filter pipeline manager may manage the printer filters based on a printer filter configuration file provided by the printer driver. The printer filter configuration file may include information about a printer filter and interface information about an input and an output of the printer filter. The printer filter pipeline manager may load and initialize the printer filters. The printer filter pipeline manager may also manage data delivery between the printer filters. The printer driver may be an Extensible Markup Language (XML) paper specification (XPS) printer driver, and may use a printing job target in an XPS format. With reference to FIGS. 4 through 7, a description will be made of an example process in which a printer filter pipeline manager configures a printer filter pipeline using a printer driver.

FIG. 4 is a diagram for describing a process of configuring a printer filter pipeline, according to an example.

Referring to FIG. 4, the processor 220 may operate by driving a plurality of sub modules in charge of specific functions. As shown in FIG. 4, the processor 220 may drive a printer filter pipeline manager to load a custom printer filter manager and may load the custom printer filter manager based on a printer filter configuration file provided by a printer driver. In this case, when the printer filter configuration file includes information related to a printer filter provided by the printer driver, the printer filter may also be loaded together.

The printer filter configuration file may include information related to a printer filter required for configuration of a printer filter pipeline. For example, the printer filter configuration file may include an order of printer filters in the printer filter pipeline, printer filter interface information, input and output format information of each filter, and the like. According to an example as illustrated in FIG. 4, the printer filter configuration file may specify the custom printer filter manager as the printer filter.

FIG. 5 is a diagram for describing a printer filter configuration file, according to an example.

Referring to FIG. 5, a part of the printer filter configuration file is shown. In the example shown in FIG. 5, the custom printer filter manager is specified as the printer filter. Thus, the custom printer filter manager may also be called when the printer filter pipeline manager calls the printer filter based on the printer filter configuration file, and the custom printer filter manager may be called each time when printing is performed.

Referring back to FIG. 4, when the custom printer filter manager is loaded by the printer filter pipeline manager, the processor 220 may drive the custom printer filter manager to load a custom printer filter based on custom printer filter configuration information including information related to a user-defined custom printer filter. The custom printer filter is a user-defined printer filter, and the user may develop a printer filter to print the printing job target in a user-desired manner. Also, the user may add the printer filter to the custom printer filter configuration information. That is, the custom printer filter may be added by the user to the custom printer filter configuration information after release of the printer driver. However, to prevent the use of a custom printer filter for malicious purposes, only a custom printer filter authorized by a vendor of the printer driver may be used. Such custom printer filter configuration information may be used by plugging in the printer driver.

The custom printer filter configuration information may include information about a custom printer filter and interface information about an input and an output of the custom printer filter. For example, the custom printer filter configuration file may include an order of custom printer filters in the printer filter pipeline, custom printer filter interface information, input and output format information of each custom filter, and the like.

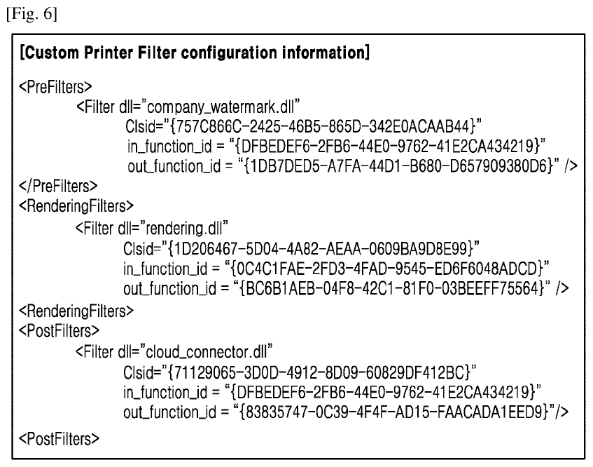

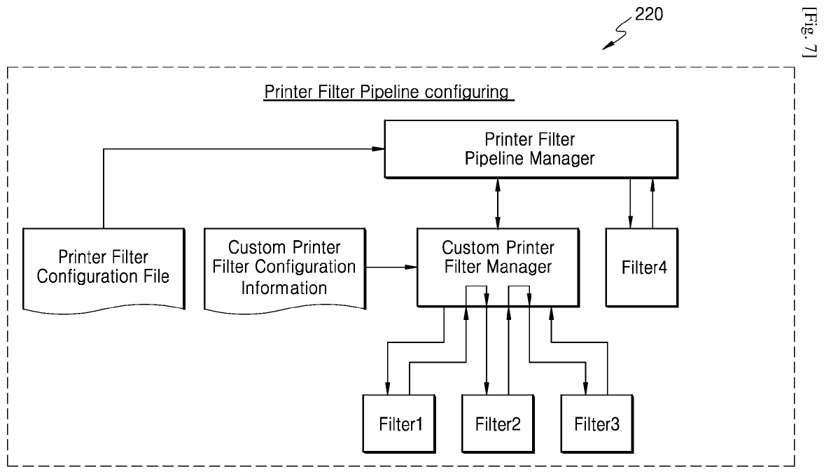

FIG. 6 is a diagram for describing custom printer filter configuration information, according to an example.

Referring to FIG. 6, the custom printer filter configuration information may include a type of a custom printer filter, an order of custom printer filters, and interface information about an input and an output of the custom printer filter.

According to the custom printer filter configuration information shown in FIG. 6, the custom printer filter manager may identify a pre-filter and load “company_watermark.dll” as the first custom printer filter. In the described example, “company_watermark.dll” is a custom printer filter that adds a logo or a phrase of a company, etc. to a printing job target in an XPS format. “company_watermark.dll” may receive the XPS-format printing job target by initializing a COM interface using “in_function_id” through an interface that is to receive the XPS-format printing job target, and output a printer-filter-processed XPS-format printing job target to the custom printer filter manager by initializing the COM interface using “output_function_id”. The XPS-format printing job target received from the custom printer filter “company_watermark.dll” may be in a form in which the company's logo or phrase is added to the XPS-format printing job target delivered through the printer filter pipeline manager.

The custom printer filter manager may identify a rendering filter and load “rendering.dll” as the second custom printer filter. The custom printer filter manager may deliver the XPS-format printing job target output from a previous printer filter, that is, the first custom printer filter “company_watermark.dll” to the second custom printer filter “rendering.dll”, and deliver the XPS-format printing job target output from “rendering.dll” to the next custom printer filter.

The custom printer filter manager may identify a post-filter and load “Cloud_connect.dll” as the third custom printer filter. The custom printer filter manager may deliver the XPS-format printing job target output from the second custom printer filter “rendering.dll” to the third custom printer filter “Cloud_connector.dll”. “Cloud_connector.dll” may upload the delivered XPS-format printing target to a cloud server.

Referring back to FIG. 4, the custom printer filter manager may load custom printer filters 1 to 3 based on custom printer filter configuration information. As described with reference to FIG. 6, the custom printer filter manager may arrange the custom printer filters 1 to 3 based on an order and operations of the custom printer filters, determined from the custom printer filter configuration information. As shown in FIG. 4, the XPS-format printing job target delivered through the printer filter pipeline manager may be input to a custom printer filter 1 by the custom printer filter manager. The XPS-format printing job target output from the custom printer filter 1 may be input to a custom printer filter 2 by the custom printer filter manager. The XPS-format printing job target output from the custom printer filter 2 may be input to a custom printer filter 3 by the custom printer filter manager. The final XPS-format printing job target output from the custom printer filter 3 may be delivered to a port monitor and transmitted to the image forming apparatus 100 to perform printing.

FIG. 7 is a diagram for describing a process of configuring a printer filter pipeline, according to an example.

Referring to FIG. 7, when compared to the example process of configuring the printer filter pipeline in FIG. 4, the printer filter pipeline manager may further load a printer filter 4. That is, the printer filter pipeline manager may further load the printer filter 4 together with the custom printer filter manager, based on the printer filter configuration file. Based on the printer filter configuration file, according to an operating order of printer filters provided by the printer driver and the custom printer filter manager, the processor 220 may load the printer filters together with the custom printer filter manager. The printer filter 4, which is provided by the printer driver, may have been loaded together with the custom printer filter manager according to the operating order. Although only the printer filter 4 is shown in FIG. 7, all printer filters specified in the printer filter configuration file may be loaded.

As illustrated in FIG. 7, the XPS-format printing job target delivered through the printer filter pipeline manager may sequentially pass through the custom printer filter 1, the custom printer filter 2, and the custom printer filter 3, by the custom printer filter manager. The XPS-format printing job target output from the custom printer filter 3 may be delivered to the printer filter pipeline manager by the custom printer filter manager. The printer filter pipeline manager may deliver the XPS-format printing job target output from the custom printer filter 3 to the printer filter 4, and deliver the final XPS-format printing job target output from the printer filter 4 to the port monitor to transmit the same to the image forming apparatus 100 to perform printing.

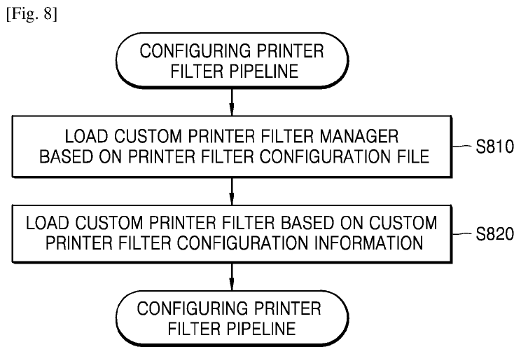

FIG. 8 is a flowchart for describing a method of configuring a printer filter pipeline, according to an example.

Referring to FIG. 8, the apparatus 200 for configuring the printer filter pipeline may load a custom printer filter manager based on a printer filter configuration file provided by a printer driver by driving a printer filter pipeline manager in operation 5810. The custom printer filter manager may be specified as a printer filter in the printer filter configuration file. Based on the printer filter configuration file, according to an operating order of printer filters provided by the printer driver and the custom printer filter manager, the printer filter pipeline manager may load the printer filters together with the custom printer filter manager.

The apparatus 200 for configuring the printer filter pipeline may load a custom printer filter based on custom printer filter configuration information including information related to a user-defined custom printer filter by driving the custom printer filter manager in operation 5820. The custom printer filter configuration information may include information about the custom printer filter and interface information about an input and an output of the custom printer filter. The custom printer filter may be added by the user to the custom printer filter configuration information after release of the printer driver, and may have been authorized by a vendor of the printer driver.

The printer filter pipeline configured using the method for configuring the printer filter pipeline may be customized for the user. The vendor offering the printer driver may offer one printer driver for each type and model of the image forming apparatus 100, and the user may develop the printer driver to configure the printer filter pipeline as desired. Thus, the apparatus 200 for configuring the printer filter pipeline may dynamically configure the printer filters constituting the printer filter pipeline to satisfy a user's demands.

The foregoing disclosure may be implemented in the form of a non-transitory computer-readable storage medium having stored therein instructions or data executable by a computer or a processor. The foregoing disclosure may also be written as programs executable on computers, and may be implemented on general-purpose digital computers operating the programs by using computer-readable storage media. Examples of the computer-readable storage media may include read-only memory (ROM), random-access memory (RAM), flash memory, compact disc (CD)-ROMs, CD-recordables (CD-Rs), CD+Rs, CD-rewritables (RWs), CD+RWs, digital versatile disc (DVD)-ROMs, DVD-Rs, DVD+Rs, DVD-RWs, DVD+RAMs, Blueray (BD)-ROMs, BD-recordables (Rs), BD-R low-to-high (LTHs), BD-rewritables (REs), magnetic tapes, floppy disks, magneto-optical data storage devices, optical data storage devices, hard disks, solid state disks (SSDs), and any device capable of storing instructions or software, related data, data files, and data structures, and providing the instructions or the software, the related data, the data files, and the data structures to a processor or a computer to enable the processor or the computer to execute the instructions.

While this disclosure has been shown and described with reference to examples thereof, it will be understood by one of ordinary skill in the art that various changes in form and details may be made therein without departing from the spirit and scope of the disclosure. That is, the scope of the disclosure is defined not by the description of the disclosure but by the appended claims, and all differences within the scope will be construed as being included in the present disclosure.

1. An apparatus for configuring a printer filter pipeline, the apparatus comprising:
a processor; and
a memory storing instructions executable by the processor,
wherein the processor is to execute the instructions to:
drive a printer filter pipeline manager to load a custom printer filter manager based on a printer filter configuration file provided by a printer driver; and
drive the custom printer filter manager to load a custom printer filter based on custom printer filter configuration information comprising information related to a custom printer filter defined by a user.

2. The apparatus of claim 1, wherein the custom printer filter manager is included as a printer filter in the printer filter configuration file.

3. The apparatus of claim 1, wherein the custom printer filter manager comprises information about the custom printer filter and interface information about an input and an output of the custom printer filter.

4. The apparatus of claim 1, wherein the custom printer filter is added to the custom printer filter configuration information by the user after release of the printer driver.

5. The apparatus of claim 1, wherein a vendor of the printer driver authorizes the custom printer filter.

6. The apparatus of claim 1, wherein the memory stores further instructions that cause the processor to, based on the printer filter configuration file, according to an operating order of printer filters provided by the printer driver and the custom printer filter manager, execute the instructions to load the printer filters together with the custom printer filter manager.

7. The apparatus of claim 1, wherein the printer filter pipeline is customized for the user.

8. A method of configuring a printer filter pipeline, the method comprising:
loading, by a printer filter pipeline manager, a custom printer filter manager based on a printer filter configuration file provided by a printer driver; and
loading, by the custom printer filter manager, a custom printer filter based on custom printer filter configuration information comprising information related to a custom printer filter defined by a user.

9. The method of claim 8, wherein the custom printer filter manager is included as a printer filter in the printer filter configuration file.

10. The method of claim 8, wherein the custom printer filter manager comprises information about the custom printer filter and interface information about an input and an output of the custom printer filter.

11. The method of claim 8, wherein the custom printer filter is added to the custom printer filter configuration information by the user after release of the printer driver.

12. The method of claim 8, wherein a vendor of the printer driver authorizes the custom printer filter.

13. The method of claim 8, wherein the loading of the custom printer filter manager comprises, based on the printer filter configuration file, according to an operating order of printer filters provided by the printer driver and the custom printer filter manager, loading the printer filters together with the custom printer filter manager.

14. The method of claim 8, wherein the printer filter pipeline is customized for the user.

15. A non-transitory computer-readable storage medium storing instructions executable by a processor, the non-transitory computer-readable storage medium comprising:
instructions to load, by a printer filter pipeline manager, a custom printer filter manager based on a printer filter configuration file provided by a printer driver; and
instructions to load, by the custom printer filter manager, a custom printer filter based on custom printer filter configuration information comprising information related to a custom printer filter defined by a user.
